(19) United States
(12) Patent Application Publication
(10) Pub. No.: US 2013/0083531 A1
(43) Pub. Date: Apr. 4, 2013

(54) LED LAMP WITH CHANGEABLE LIGHT INTENSITY

(71) Applicant: MIN-JET LUI, Chu-Nan (TW)

(72) Inventor: MIN-JET LUI, Chu-Nan (TW)

(73) Assignee: FOXSEMICON INTEGRATED TECHNOLOGY, INC., Chu-Nan (TW)

(21) Appl. No.: 13/594,854

(22) Filed: Aug. 26, 2012

(30) Foreign Application Priority Data
Sep. 30, 2011 (TW) 100135406

(51) Int. Cl. F21V 21/00

(52) U.S. Cl. 362/249.02

(57) ABSTRACT

An LED lamp includes a first LED light module and a second LED light module. The first LED light module includes a frame, a beam mounted on the frame, a plurality of LEDs mounted on the frame and a cover fixed to the frame to cover the LEDs. The second LED light module includes a housing, a base mounted on the housing and an LED fixed to the housing. The base of the first LED light module defines two grooves. The base of the second LED light module forms two posts. The two posts can be locked in the two grooves to mount the first LED light module with the second LED light module and complete the electrical connection between the first and second LED light modules.

### BACKGROUND

1. Technical Field

The present disclosure relates to LED (light emitting diode) lamps, and more particularly, to an LED lamp having changeable light intensity.

2. Description of Related Art

As new type of light source, LEDs are widely used in various applications, such as road lamps, traffic lamps, tunnel lamps, resident lamps and so on. A conventional LED lamp includes a shell, a plurality of LEDs mounted in the shell and a cover fixed to the shell and covering the LEDs. In operation, the LEDs are activated to lighten to illuminate a predetermined area.

However, the light intensity of the conventional LED lamp is generally fixed. That is to say, if brighter illumination is required for the predetermined area, the whole LED lamp should be replaced by another LED lamp having higher power. The replacement of the LED lamp with another LED lamp is costly, inconvenient and time-consuming.

What is needed, therefore, is an LED lamp with changeable light intensity which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an LED lamp in accordance with an embodiment of the present disclosure.

FIG. 2 is an exploded view of the LED lamp of FIG. 1.

FIG. 3 is an inverted view of the LED lamp of FIG. 2, with a cover thereof being removed.

FIG. 4 is an enlarged view of a second LED light module of the LED lamp of FIG. 2.

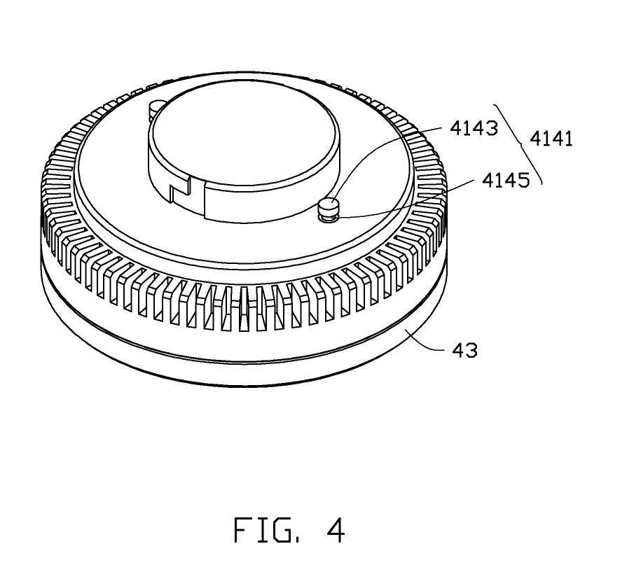

### DETAILED DESCRIPTION OF THE EMBODIMENTS

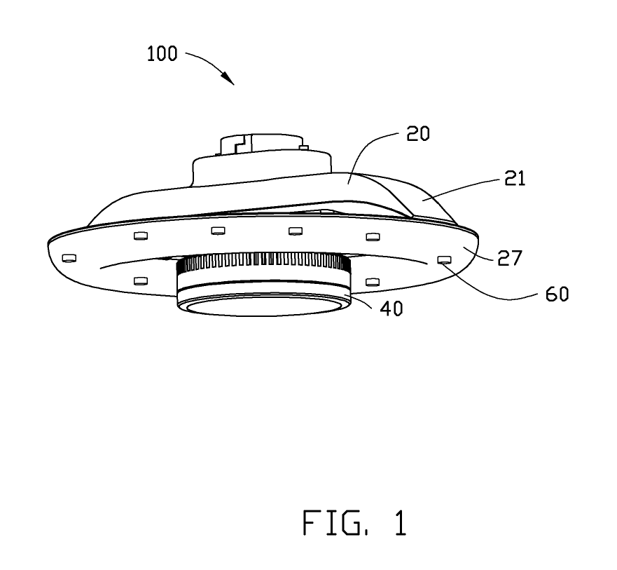

FIG. 1 shows an LED lamp 100 in accordance with an embodiment of the present disclosure. The LED lamp 100 includes a first LED light module 20 and a second LED light module 40 detachably mounted to the first LED light module 20.

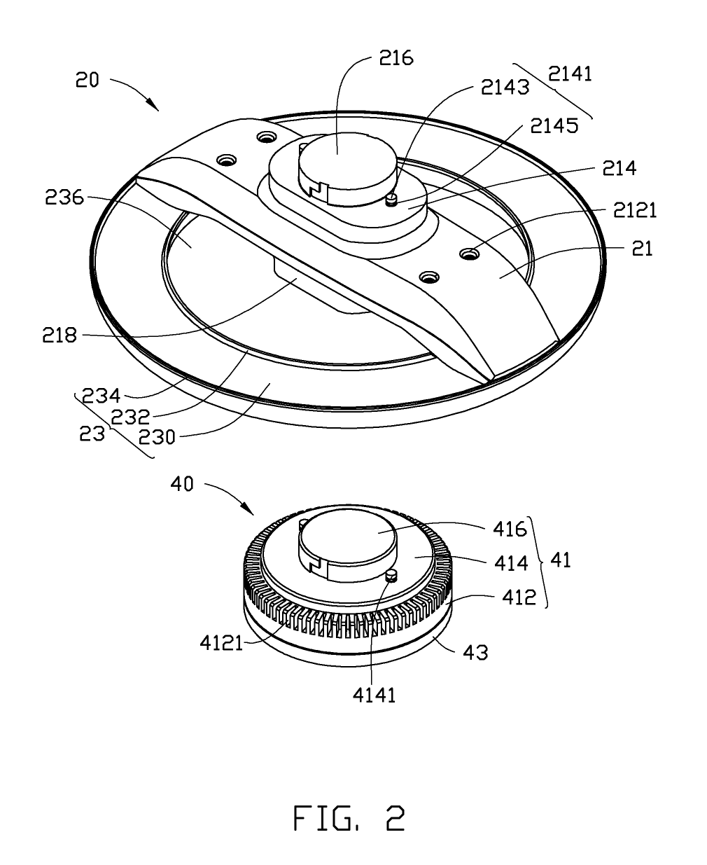

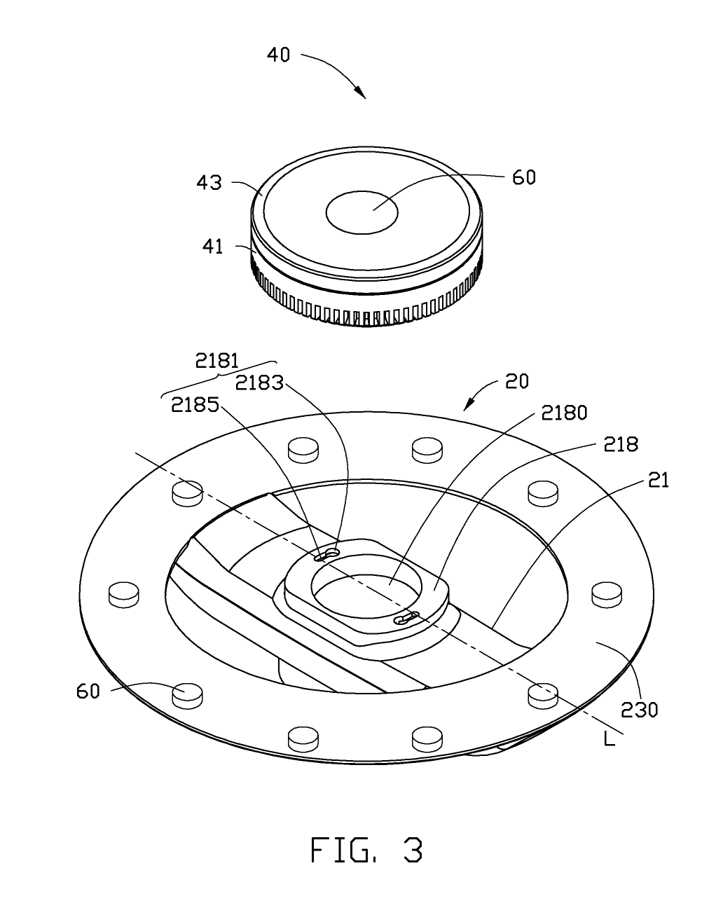

Also referring to FIGS. 2-3, the first LED light module 20 includes an annular frame 23, a beam 21 fixed to the frame 23, a lower base 218 and an upper base 214 fixed to the beam 21, a plurality of LEDs 60 mounted on the frame 23 and a cover 27 attached to the frame 23 to cover the LEDs 60.

The frame 23 includes an annular plate 230 and an inner flange 232 and an outer flange 234 extending upwardly from an inner circumferential periphery and an outer circumferential periphery of the plate 230. The two flanges 232, 234 are parallel to each other and perpendicular to the plate 230. The LEDs 60 are mounted to a bottom face of the plate 230 in an annular distribution. In other words, the LEDs 60 are evenly spaced from each other and cooperatively form an annulus. The inner flange 232 surrounds a circular space 236 therein.

The beam 21 is fixed on the annular frame 23 and spans across the space 236. The beam 21 has two opposite ends each connecting a top face of the plate 230 between the inner flange 232 and the outer flange 234. The beam 21 defines four threaded holes 2121 in a top face thereof for allowing screws (not shown) extending into the beam 21, thereby fixing the LED lamp 100 to a support (not shown) such as a ceiling or a roof. The lower base 218 is fixed to a bottom face of the beam 21 and received in the space 236. The lower base 218 defines a circular chamber 2180 in a central area of a bottom face thereof and two grooves 2181 next to the chamber 2180. The two grooves 2181 (i.e., a right groove and a left groove) are located adjacent to two opposite lateral sides of the base 218. Each groove 2181 includes a circular hole 2183 and an elongated slot 2185 communicating with the hole 2183. The hole 2183 has a diameter larger than a width of the slot 2185. The slot 2185 extends along a circumference of a circle having a center coincident with a center of the circular chamber 2180. The beam 21 forms two spring contacts (not visible) in the two grooves 2181, respectively. An imaginary line L is defined through a center of the chamber 2180 and parallel to a lengthwise direction of the beam 21. The two holes 2183 are located at two sides of the imaginary line L. In this embodiment as shown in FIG. 3, both the holes 2183 are deviated from the imaginary line L along a clockwise direction. The clockwise direction of FIG. 3 is an anticlockwise direction in FIG. 2 since FIG. 3 is an inverted view of FIG. 2. Thus, the hole 2183 of the right groove 2181 is located in rear of the imaginary line L, and the hole 2183 of the left groove 2181 is located in front of the imaginary line L, as viewed from FIG. 3. The slot 2185 of the right groove 2181 extends from the hole 2183 along a counterclockwise direction, and the slot 2185 of the left groove 2181 extends from the hole 2183 along the anticlockwise direction as well. Both the slots 2185 intersect with the imaginary line L.

Returning to FIG. 2, the upper base 214 is fixed to the top face of the beam 21. The upper base 214 has a size and shape similar to that of the lower base 218. A circular block 216 protrudes upwardly from a central area of a top face of the upper base 214. A pair of posts 2141 are formed on the top face of the upper base 214 neighboring the block 216. The posts 2141 are electrically connected to the LEDs 60 and the spring contacts in the grooves 2181. The block 216 and the two posts 2141 are located corresponding to the chamber 2180 and the two grooves 2181, respectively. The block 216 has a height larger than that of each post 2141. The block 216 has a size slightly less than that of the chamber 2180. Each post 2141 includes a pole 2145 connecting the upper base 214 and a head 2143 formed on a top of the pole 2145. The head 2143 has a diameter larger than that of the pole 2145. The diameter of the head 2143 is less than the diameter of the hole 2183 and larger than the width of the slot 2185. The diameter of the pole 2145 is less than the width of the slot 2185.

The cover 27 is annular and fixed on the bottom face of the plate 230. The cover 27 together with the frame 21 seals the LEDs 60 from an outside environment. The cover 27 may be made of transparent or translucent materials such as glass, silicone or plastic. Thus, light emitted from the LEDs 60 can downwardly pass through the cover 27 to illuminate a predetermined area (not shown) below the LED lamp 100.

The second LED light module 40 includes a housing 41, an LED 60 mounted in the housing 41 and a cover 43 fixed to the housing 41 to cover the LED 60. The housing 41 includes a heat sink 412, a base 414 formed on the heat sink 412 and a block 416 formed on the base 414. The heat sink 412 forms a plurality of fins 4121 at a top thereof for facilitating heat dissipation of the LED 60. The base 414 is formed on a top face of the heat sink 412. Two posts 4141 extend upwardly from a top face of the base 414. The posts 4141 are located adjacent to the block 416. Each post 4141 includes a pole 4145 and a head 4143 formed on the pole 4145. The pole 4145 and the head 4143 of each post 4141 of the second LED light module 40 have configurations the same as those of the pole 2145 and the head 2143 of each post 2141 of the first LED light module 20. The block 416 of the second LED light module 40 has the same configuration as that of the block 216 of the first LED light module 20. The LED 60 is mounted on a bottom face of the heat sink 412. The LED 60 is electrically connected to the two posts 4141. The cover 43 is fixed to the bottom face of the heat sink 412. Light emitted from the LED 60 passes through the cover 43 to illuminate the predetermined area. The power of the LED 60 of the second LED light module 40 is less than the total power of the LEDs 60 of the first LED light module 20.

In assembly of the second LED light module 40 to the first LED light module 20, the posts 4141 of the second LED light module 40 are brought to in alignment with the two holes 2183 of the two grooves 2181 of the first LED light module 20. The posts 4141 of the second LED light module 40 are then inserted into the two holes 2183 of the first LED light module 20. The second LED light module 40 is then rotated so that the poles 4145 of the two posts 4141 move into the slots 2185 of the grooves 2181 of the first LED light module 20. The heads 4143 are held above the slots 2185 to mount the second LED light module 40 to the first light module 20. The posts 4141 of the second LED light module 40 contact the spring contacts in the two grooves 2181 to be in electrical connection with the first LED light module 20. Thus, the LED 60 of the second LED light module 40 is also electrically connected to the first LED light module 20.

In use, the first LED light module 20 can work by itself to illuminate the predetermined area. If brighter illumination is required for the predetermined area, the second LED light module 40 can be added to the first LED light module 20 to work together with the first LED light module 20. Thus, much more light can be provided by the LED lamp 100.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An LED (light-emitting diode) lamp comprising:
a first LED light module comprising a frame, a beam connected to the frame, an LED mounted to the frame, and a base connected to the frame;
a second LED light module comprising a housing, a base connected to the housing and an LED mounted to the housing;
wherein one of the first LED light module and the second LED light module comprises a pair of posts formed on the base thereof, and the other one of the first LED light module and the second LED light module comprises a pair of grooves defined in the base thereof; and
wherein the posts are respectively lockable in the grooves by firstly inserting the posts in the to grooves and then rotating one of the first and second LED light modules relative to the other to mount the second LED light module to the first LED light module and complete an electrical connection between the first and second LED light modules.

2. The LED lamp of claim 1, wherein each of the grooves comprises a hole and a slot communicating with the hole, the slot having a width less than a diameter of the hole.

3. The LED lamp of claim 2, wherein each of the posts comprises a pole and a head formed on the pole, the head having a diameter larger than that of the pole.

4. The LED lamp of claim 3, wherein the diameter of the head is larger than the width of the slot and less than the diameter of the hole, and the diameter of the pole is less than the width of the slot.

5. The LED lamp of claim 4, wherein each of the posts is lockable in a corresponding groove by extending the head of the post into the hole, and then moving the pole into the slot.

6. The LED lamp of claim 2, wherein the slots of the two grooves extend along a same one of a clockwise or an anticlockwise direction.

7. The LED lamp of claim 2, wherein the posts are formed on the base of the second LED light module, and the grooves are defined in the base of the first LED light module.

8. The LED lamp of claim 7, wherein the base of the first LED light module defines a chamber in a bottom face thereof, the base of the second LED light module forms a block protruding upwardly from a top face thereof, the block being received in the chamber when the posts are locked in the grooves.

9. The LED lamp of claim 8, wherein the chamber is defined in a central area of the bottom face of the base of the first LED light module, the grooves being located at two opposite sides of the chamber.

10. The LED lamp of claim 9, wherein an imaginary line is defined through a center of the chamber and along an elongated direction of the beam, the two holes of the two grooves being located at two sides of the imaginary line, respectively.

11. The LED lamp of claim 10, wherein the two slots of the two grooves intersect with the imaginary line.

12. The LED lamp of claim 8, wherein the first LED light module further comprises another base formed on the beam, the beam being located between the base and the another base of the first LED light module.

13. The LED lamp of claim 12, wherein the first LED light module further comprises two posts and a block formed on the another base, the two posts of the first LED light module on the another base being located at two opposite sides of the block on the another base of the first LED light module.

14. The LED lamp of claim 13, wherein the posts of the first LED light module have the same configurations as those of the posts of the second LED light module, and the block on the another base of the first LED light module has the same configuration as that of the block of the second LED light module.

15. The LED lamp of claim 7, wherein the LED of the second LED light module is electrically connected to the two posts of the second LED light module.

16. The LED lamp of claim 1, wherein the frame comprises an annular plate and two flanges extending upwardly from an inner circumferential periphery and outer circumferential periphery of the plate, respectively, the LED being mounted on a bottom face of the plate.

17. The LED lamp of claim 16, wherein the beam comprises two opposite ends each connecting the plate between the two flanges.

18. The LED lamp of claim 16, wherein the base of the first LED light module is surrounded by the flanges.
